(19) United States
(12) Patent Application Publication
(10) Pub. No.: US 2026/0273407 A1
(43) Pub. Date: Sep. 17, 2026

(54) ONE OR MORE NON-TRANSITORY COMPUTER-READABLE STORAGE MEDIA, COMPUTER-IMPLEMENTED METHOD, AND GAME SYSTEM

(71) Applicant: Nintendo Co., Ltd., Kyoto-shi (JP)

(72) Inventor: Keisuke IBA, Kyoto-shi (JP)

(21) Appl. No.: 19/679,321

(22) Filed: May 15, 2026

Related U.S. Application Data
(63) Continuation of application No. PCT/JP2023/041592, filed on Nov. 20, 2023.

(51) Int. Cl. A63F 13/54; A63F 13/428; G06F 3/0346; G06F 3/0354; G06F 3/16

(52) U.S. Cl. CPC A63F 13/54; A63F 13/428; G06F 3/0346; G06F 3/03543; G06F 3/165

(57) ABSTRACT

A processor of an information processing apparatus is caused to: acquire first data outputted from a mouse and related to an attitude of the mouse; acquire second data outputted from the mouse and related to movement of the mouse on a work surface; determine, based on the acquired first data, a first parameter related to sound data; and output, based on the acquired second data, the sound data determined based on the first parameter.

### CROSS REFERENCE TO RELATED APPLICATION

This application is a continuation of International Application No. PCT/JP2023/041592, filed Nov. 20, 2023, the entire contents of which are incorporated herein by reference.

### FIELD

The present disclosure relates to information processing for controlling sound output.

### BACKGROUND AND SUMMARY

Conventionally, game processing using a mouse has been known.

In the above technology, there is room to provide a novel game having new operability and game characteristics using a mouse.

In view of the above circumstances, for example, configuration examples are given below.

### Configuration 1

A configuration 1 is directed to one or more non-transitory computer-readable storage media having stored therein instructions that cause one or more processors to perform operations including: acquiring first data outputted from a mouse and related to an attitude of the mouse; acquiring second data outputted from the mouse and related to movement of the mouse on a work surface; determining a first parameter related to sound data, based on the acquired first data; and outputting, based on the acquired second data, the sound data determined based on the first parameter.

According to the above configuration example, since the attitude of the mouse and the movement of the mouse are used to perform sound output, it is possible to provide a game exhibiting novel and unprecedented amusement.

### Configuration 2

In a configuration 2 based on the above configuration 1, the game operations further include: determining, based on the acquired second data, a second parameter different from the first parameter and related to the sound data; and outputting the sound data based on the first parameter and the second parameter.

According to the above configuration example, since the second parameter based on the movement of the mouse is further used, for example, it is possible to increase the variation of changes in sounds to be outputted.

### Configuration 3

In a configuration 3 based on the above configuration 2, the second parameter may be determined based on a movement direction of the mouse determined based on the second data.

According to the above configuration example, it is possible to, for example, output different sounds in accordance with the movement direction of the mouse.

### Configuration 4

In a configuration 4 based on the above configuration 3, the second parameter may be determined based on whether the movement direction of the mouse determined based on the second data is a first direction or a second direction opposite to the first direction.

According to the above configuration example, it is possible to express, in game processing, a change in a sound caused by, for example, a reciprocating motion such as “up-bow” and “down-bow” motions in an actual violin.

### Configuration 5

In a configuration 5 based on any one of the above configurations 2 to 4, the game operations may further include determining, based on a movement speed of the mouse determined based on the second data, a third parameter different from the first parameter and the second parameter and related to the sound data.

According to the above configuration example, it is possible to provide amusement of changing a sound to be outputted in accordance with the movement speed of the mouse.

### Configuration 6

In a configuration 6 based on any one of the above configurations 1 to 5, the game operations may further include stopping output of the sound data when a series of movement distances of the mouse in a same direction, determined based on the second data, reaches a specified distance or more.

According to the above configuration example, it is possible to provide, for example, a play experience that simulates a situation where the range within which the bow can be moved, i.e., the range within which a sound can be produced, is finite, like with an actual violin.

### Configuration 7

In a configuration 7 based on any one of the above configurations 1 to 6, the game operations may further include: detecting that the mouse is not moving on the work surface, based on the second data; and gradually reducing a volume of the outputted sound data from a time when the mouse is detected as not moving on the work surface.

According to the above configuration example, it is possible to suppress user-unintended sudden stop of sound output.

Each configuration example described above may be applied to a game system, a game apparatus, and a computer-implemented method.

### BRIEF DESCRIPTION OF THE DRAWINGS

FIG. 1 is a block diagram showing a non-limiting example of a hardware configuration of an information processing apparatus 2;

FIG. 2 shows a non-limiting example of the appearance of a mouse 40;

FIG. 3 illustrates a non-limiting example of an operation on the mouse 40;

FIG. 4 illustrates a non-limiting example of an operation on the mouse 40;

FIG. 5 illustrates a non-limiting example of an operation on the mouse 40;

FIG. 6 illustrates a non-limiting example of an operation on the mouse 40;

FIG. 7 illustrates a non-limiting example of an operation on the mouse 40;

FIG. 8 shows a non-limiting example of the correspondence relationship between movement of the mouse 40 and a second parameter;

FIG. 9 shows a non-limiting example of various data stored in a storage unit 22 of the information processing apparatus 2; and

FIG. 10 is a non-limiting example of a flowchart showing the details of game processing.

### DETAILED DESCRIPTION OF NON-LIMITING EXAMPLE EMBODIMENTS

### Hardware Configuration of Information Processing Apparatus 2

FIG. 1 is a block diagram showing an example of a hardware configuration of an information processing apparatus 2 according to an exemplary embodiment. In FIG. 1, the information processing apparatus 2 includes a processor 21. The processor 21 is an information processing unit that executes various types of information processing executed in the information processing apparatus 2. In the exemplary embodiment, the processor 21 is composed of an SoC (System-on-a-chip) including at least a CPU (Central Processing Unit) function and a GPU (Graphics Processing Unit) function. In another exemplary embodiment, the CPU and the GPU may be separate components. The processor 21 executes various types of information processing by executing an information processing program (e.g., a game program) stored in a storage unit 22. The storage unit 22 may be an internal storage medium such as a flash memory or a DRAM (Dynamic Random Access Memory) or may be configured to utilize an external storage medium mounted to a slot that is not shown, or the like. The information processing apparatus may be, for example, a game apparatus, a personal computer, or a server.

The information processing apparatus 2 includes a communication unit 23 for performing communication with another information processing apparatus or a specified server.

In addition, the information processing apparatus 2 includes an input device communication unit 24 for the information processing apparatus 2 to perform wired or wireless communication with various input devices. In the exemplary embodiment, the example in which a mouse 40 is used will be described as an example of the input devices.

In addition, a display unit 30 (e.g., a monitor, etc.) and a sound output unit 31 (e.g., a speaker) are connected to the information processing apparatus 2 via an image/sound output unit 25. The processor 21 outputs, for example, an image generated by execution of the above-described information processing, to the display unit 30 via the image/sound output unit 25. Similarly, the processor 21 outputs a sound generated by execution of the information processing, to the sound output unit 31 via the image/sound output unit 25.

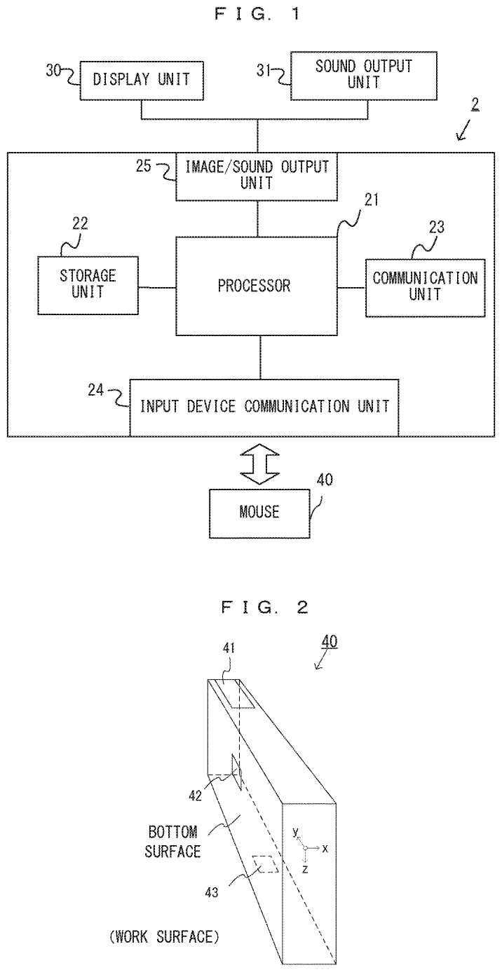

FIG. 2 is a schematic view showing an example of the appearance of the mouse 40. As shown in FIG. 2, the mouse 40 has a plate shape in which a y-axis direction is the longitudinal direction (a rectangular parallelepiped or a similar shape in which the thickness in an x-axis direction is smaller than the thickness in the y-axis direction and the thickness in a z-axis direction, and the thickness in the z-axis direction is smaller than the thickness in the y-axis direction).

The mouse 40 includes a sensor (hereinafter, referred to as a mouse sensor) that detects operations such as a user sliding the mouse 40 on a work surface (a work surface on which the bottom surface of the mouse 40 contacts in FIG. 2). The mouse sensor is provided so as to be exposed, for example, through an opening 43 provided in the bottom surface of the mouse 40. The mouse sensor is a sensor that acquires data for calculating movement (movement direction, movement distance, movement speed, etc.), on the work surface, of the mouse 40 disposed with the bottom surface thereof facing the work surface. The mouse sensor is, for example, an optical sensor or a laser sensor. Data acquired by the mouse sensor of the mouse 40 is repeatedly transmitted to the input device communication unit 24 at appropriate timings.

In addition, the mouse 40 includes an attitude sensor. Specifically, each mouse 40 includes an acceleration sensor (not shown) and an angular velocity sensor (not shown). The acceleration sensor detects the magnitudes of acceleration along the directions of specified three axes (x, y, and z axes shown in FIG. 2). The acceleration sensor may detect an acceleration along one axis direction or accelerations along two axes directions. The angular velocity sensor detects angular velocities around the specified three axes (x, y, and z axes shown in FIG. 2). The angular velocity sensor may detect an angular velocity about one axis or angular velocities about two axes. Then, the detection results of the acceleration sensor and the angular velocity sensor are repeatedly transmitted to the input device communication unit 24 at appropriate timings.

As for the attitude sensor, various sensors capable of detecting an attitude, such as a geomagnetic sensor, may be used, and multiple sensors may be used together. In addition, a plurality of optical sensors may be combined and used as the attitude sensor. For example, based on a difference between detection values of the respective optical sensors (difference in movement direction, etc.), it may be possible to detect that each mouse has been rotated, etc.

As shown in FIG. 2, the mouse 40 includes a button 41 on the top surface opposite to the bottom surface. The button 41 is located at an end in the y-axis direction on the top surface in which the y-axis direction is the longitudinal direction. The user can use the button 41 as a click button. That is, the user can operate the mouse 40 by placing a hand on the top surface of the mouse 40 so as to align the fingers with the y-axis direction. Data indicating the operation state of the button 41 is repeatedly transmitted to the input device communication unit 24 at appropriate timings.

In addition, the mouse 40 may be provided with a vibration device (not shown) that vibrates the mouse 40.

### Processing Assumed in Exemplary Embodiment

Next, an outline of information processing assumed in the exemplary embodiment will be described. In the exemplary embodiment, game processing that involves outputting a sound for fun by sliding the mouse 40 on the work surface is assumed. In the exemplary embodiment, at the time of outputting the sound, control is performed such that parameters of the sound to be outputted are changed in accordance with the attitude, the movement direction, and the movement speed of the mouse 40 at that time. Specifically, a first parameter is determined based on the change in the attitude (tilt) of the mouse 40, a second parameter and a third parameter are determined based on the movement of the mouse 40, and sound data is generated and outputted based on these parameters. Thus, the user can enjoy game processing in which various sounds are outputted by changing the attitude or the movement direction of the mouse 40.

Here, supplementary explanation will be provided regarding the change in the attitude of the mouse 40 assumed in the exemplary embodiment. In the exemplary embodiment, as the change in the attitude of the mouse 40, rotation around the x-axis (change in pitch) in FIG. 2 or rotation around the y-axis (change in roll) in FIG. 2 is mainly assumed. As a matter of course, in another exemplary embodiment, the first parameter may be determined based on rotation around the z-axis in FIG. 2. cl First Embodiment

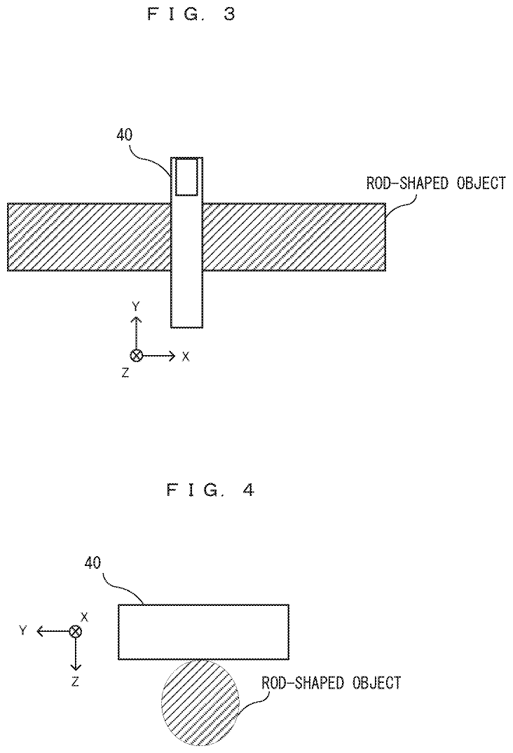

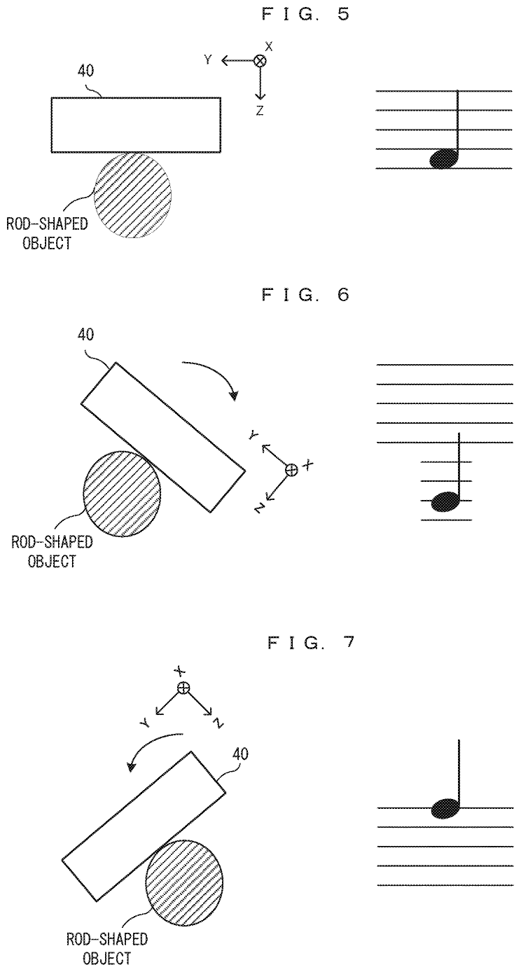

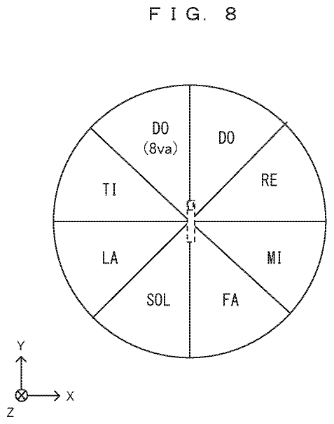

Next, as a first embodiment of the information processing, an example of an operation on the mouse 40 and sound output control will be described. In this embodiment, a description will be given assuming a case of operating the mouse 40 along, for example, a rod-shaped object. More specifically, as the rod-shaped object, a substantially cylindrical object is assumed. In other words, the surface in the longitudinal direction of the rod-shaped object serves as the work surface for the mouse 40. An example of the rod-shaped object includes the user's body, such as an arm. In this embodiment, as shown in FIG. 3, the mouse 40 is caused to take an attitude such that the longitudinal direction thereof is orthogonal to the longitudinal direction of the rod-shaped object, and then a game is started, for example. The state shown in FIG. 3, when viewed along the x-axis of the coordinate system of the mouse 40, corresponds to the attitude shown in FIG. 4. When the mouse 40 is moved along the rod-shaped object, a sound is outputted. At this time, the first parameter related to the sound to be outputted is determined based on the attitude of the mouse 40. Here, as an example, a case where the first parameter is determined based on the rotation angle around the x-axis, i.e., how much the longitudinal direction (one-axis attitude) is tilted relative to the ground (gravity direction), will be described. In this embodiment, the octave of a sound to be outputted is set as the first parameter. For example, a case where the “fa” sound is outputted when the mouse 40 is in the attitude shown in FIG. 5 is assumed. In this case, the same “fa” sound, but one octave lower, is outputted when the mouse 40 is tilted as shown in FIG. 6. In addition, the “fa” sound one octave higher is outputted when the mouse 40 is tilted as shown in FIG. 7, for example. In other words, the above case is an example where the octave changes in accordance with the tilt of the mouse 40.

In this embodiment, the second parameter is determined based on the movement contents at the time of moving the mouse 40 along the rod-shaped object. In the exemplary embodiment, the second parameter is, for example, the scale. For example, the mouse 40 may be caused to correspond to the movement in 360 degrees to output sounds in different scales. As an example, as shown in FIG. 8, control may involve dividing the inside of a virtual circular area and assigning the scales. In this case, when the initial position of the mouse 40 is assumed to be the center of the circle, the scale to be outputted may be determined based on the movement direction from the center (the relative position from the center). Alternatively, the scale to be outputted may be determined based on the movement direction from the current position of the mouse 40.

In this embodiment, the third parameter is determined based on the movement speed of the mouse 40. The third parameter is, for example, the volume. The parameter is set such that as the movement speed increases, the volume of an output sound increases. In this embodiment, once the movement of the mouse 40 is no longer detected, control for gradually attenuating the volume is also performed from that time point. For example, when the mouse 40 is moved in the short direction of the rod-shaped object, the mouse sensor may immediately become unable to detect reflected light due to the curvature of the surface of the rod-shaped object. In this case, immediately stopping sound output in response to the fact that the reflected light is no longer detected may lead to a sense of discomfort or reduction in amusement of the game. Therefore, in this embodiment, instead of stopping the sound output immediately, control for gradually attenuating the volume is performed. The third parameter may not necessarily be the volume itself, but may be a parameter for increasing or decreasing the volume.

In accordance with the movement contents of the mouse 40 moved as described above and the attitude thereof at that time, various sounds with different combinations of the octave, scale, and volume can be outputted.

The contents used as the first parameter, the second parameter, and the third parameter are not limited to those described above. For example, vibrato, tone color, the number of sounds (such as the number of strings of a violin or a guitar for producing sounds), or the like may be used as the above-described parameters.

### Example of Used Data

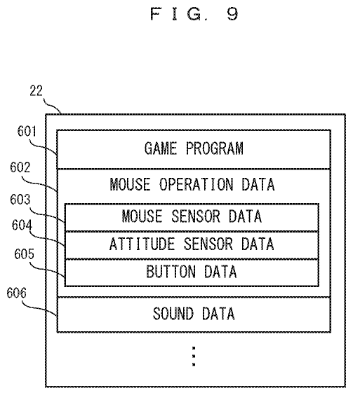

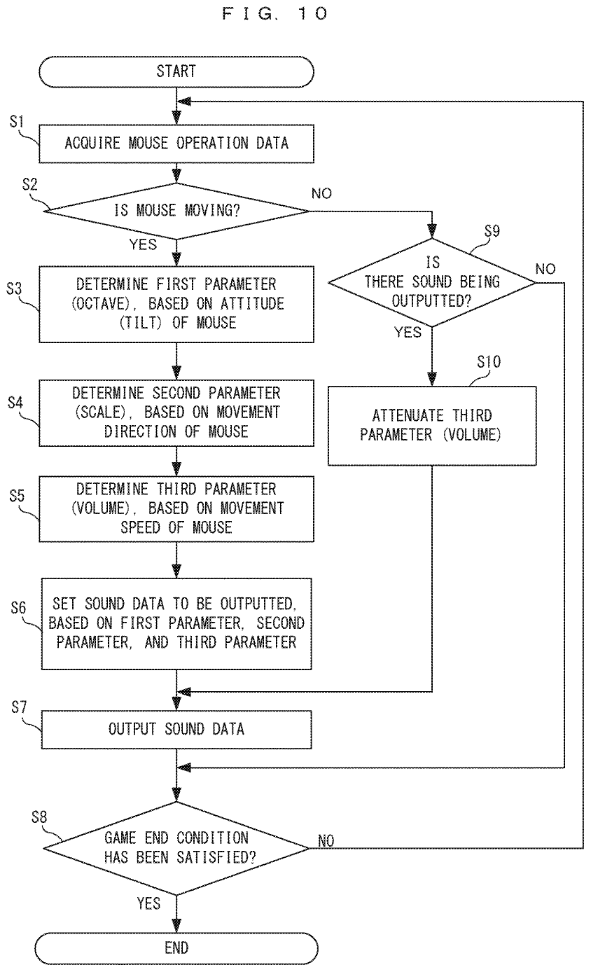

Next, various data to be used in the game processing of this embodiment will be described. FIG. 9 is a memory map showing an example of various data stored in the storage unit 22 of the information processing apparatus 2. In the storage unit 22, a game program 601, mouse operation data 602, sound data 606, and the like are stored.

The game program 601 is a program containing computer-executable instructions for executing the game processing according to the exemplary embodiment.

The mouse operation data 602 is data for showing the operation contents performed on the mouse 40. The mouse operation data 602 includes mouse sensor data 603, attitude sensor data 604, and button data 605. The mouse sensor data 603 is data outputted from the mouse sensor of the mouse 40. The mouse sensor data 603 includes data indicating the amount of movement and the movement direction of the mouse 40 on the work surface. The attitude sensor data 604 is data outputted from the attitude sensor. In this embodiment, the attitude sensor data 604 includes acceleration data and angular velocity data around the specified three axes. The button data 605 is data indicating the pressed state of each button of the mouse 40.

The sound data 606 is sound data generated based on the various parameters as described above.

### Example of Flowchart

Next, an example of a flowchart of the game processing in this embodiment will be described. In this example, one or more processors read and execute a program stored in one or more memories, whereby the flowchart indicated below is realized. In addition, the flowchart is merely one example of the processing procedure. Therefore, as long as a similar result is obtained, processing orders of respective steps may be switched. In addition, values of variables and thresholds used in determination steps are also merely examples, and other values may be adopted as necessary.

FIG. 10 is an example of a flowchart showing the details of the above-described game processing. A process loop from step S1 to step S8 in FIG. 10 is repeated a plurality of times per second in accordance with the frame rate.

First, in step S1, the processor 21 acquires the mouse operation data 602.

Next, in step S2, the processor 21 determines whether or not the mouse 40 is in a moving state. For example, the processor 21 determines whether or not the mouse 40 is moving by determining whether or not the amount of movement of the mouse 40 included in the mouse sensor data 603 is zero. If, as a result of the determination, the mouse is in the moving state (YES in step S2), a process of setting the various parameters is performed in accordance with the contents of the movement or the attitude of the mouse 40 at that time. Specifically, first, in step S3, the processor 21 calculates the change in the attitude of the mouse 40 in a specified unit time (e.g., one frame), based on the attitude sensor data 604 included in the mouse operation data 602. In this embodiment, the rotation angle around the x-axis in FIG. 2 is calculated based on the angular velocity data. Furthermore, the processor 21 calculates the rotation angle of the mouse 40, based on the calculated change in the attitude and determines the first parameter (the octave in this embodiment). As the determination method, for example, a specified formula for converting the rotation angle into the first parameter may be used. In addition, the determination may be performed with reference to, for example, table data that defines in advance the correspondence relationship between the rotation angle and the first parameter.

Next, in step S4, the processor 21 calculates the movement direction of the mouse 40 in the specified unit time, based on the mouse sensor data 603. Furthermore, the processor 21 determines the second parameter (the scale in this embodiment), based on the movement direction. Similarly, the second parameter may be determined with reference to, for example, table data that defines in advance the correspondence relationship between the movement direction and the second parameter, or may be determined through calculation using a specified formula.

Next, in step S5, the processor 21 calculates the movement speed of the mouse 40 in the specified unit time, based on the mouse sensor data 603. The amount of movement included in the mouse sensor data 603 may be directly used as the movement speed, or the movement speed may be calculated from the amount of movement. Then, the processor 21 determines the third parameter, based on the movement speed. In this embodiment, since the third parameter is the volume, the third parameter is determined such that as the movement speed increases, the volume increases, for example.

Next, in step S6, the processor 21 generates, based on the first parameter and the second parameter, the sound data 606 to be outputted. In this embodiment, the sound data 606 having a scale determined based on the movement of the mouse 40 and an octave determined based on the tilt of the mouse 40 is generated. Furthermore, based on the third parameter, the processor 21 sets the volume for outputting a sound related to the sound data 606.

Next, in step S7, the processor 21 outputs a sound signal based on the sound data 606 to the sound output unit 31.

Meanwhile, if, as a result of the determination in step S2, the mouse 40 is not moving (NO in step S2), in step S9, the processor 21 determines whether or not there is a sound currently being outputted (a sound being outputted based on the processes up to the previous frame). If there is a sound being outputted (YES in step S9), in step S10, the processor 21 determines the third parameter such that the volume gradually attenuates toward zero. Then, the process proceeds to step S7.

Meanwhile, if there is no sound being outputted (NO in step S9), the process proceeds to the next step, S8.

Next, in step S8, the processor 21 determines whether or not a specified game end condition has been satisfied. If the game end condition has not yet been satisfied (NO in step S8), the process returns to step S1 and is repeated. If the condition is satisfied (YES in step S8), the processor 21 ends the game processing.

This is the end of the description of the example of the flowchart.

As described above, in the first embodiment, the first parameter (octave) and the second parameter (scale) are determined based on the movement and the attitude of the mouse 40, and a sound based on these parameters is outputted. Thus, by moving the mouse 40 along the rod-shaped object as described above, for example, it is possible to provide enjoyment of producing various sounds in accordance with the movement direction and the change in the attitude of the mouse 40.

### Second Embodiment

Next, as a second embodiment, an example of an aspect of game processing in which the movement direction of the mouse 40 is treated in a somewhat limited manner compared with the first embodiment will be described. The game is, for example, a game that provides an operation experience that simulates playing a violin.

In the second embodiment, only one straight-line direction (or two directions if regarded as a reciprocating motion) is used as the movement direction of the mouse 40. This is based on an assumed movement of a violin bow. As an example, the straight-line direction is the y-axis direction of the mouse 40, i.e., the short direction of the rod-shaped object. Thus, in the second embodiment, control is performed such that, in the processes as shown in the first embodiment, movement in a perpendicular direction with respect to the one straight-line direction is ignored, for example.

In the second embodiment, in a case where the mouse 40 is moved on a limited work surface when operated in a reciprocating motion, the output sound is changed depending on which direction the mouse 40 is moved in. In other words, the second parameter is determined by the movement direction of the mouse 40 in the reciprocating motion. Thus, it is possible to perform control for simulating, for example, sounds at the time of “up-bow” and “down-bow” in violin playing. An example of bowing of a violin has been described in this embodiment. In addition thereto, regarding a game where a virtual guitar is played, the difference in movement direction in such a reciprocating motion may be utilized as the order of plucking the strings of the virtual guitar, for example.

In the second embodiment, control is also performed such that when the mouse 40 is moved a certain distance or more in the same direction, no further sound is outputted unless the movement direction is changed. In other words, control for simulating a situation where the range within which a sound can be produced is finite, like with an actual violin bow, is performed. For example, the movement distance of the mouse 40 in the same direction is counted, and, when the distance reaches a specified value or more, control for stopping the sound output is performed. Then, when a change in the movement direction is detected thereafter, control for cancelling the stop of the sound output is performed.

In the second embodiment, it may be possible to perform an operation only with the mouse 40, as well as an operation with another controller together with the mouse 40. For example, an operation in which the user holds the other controller with the left hand and holds the mouse 40 with the right hand, and moves the mouse 40 or changes the attitude thereof along the left arm is assumed. In such an operation, control may be performed such that a pressed string of the virtual violin changes (i.e., a sound changes) in accordance with a button operation on, or the angle or the like of, the other controller.

### Modifications

In the above embodiments, the mouse sensor detects movement of the mouse and outputs the movement direction, the amount of movement, etc., of the mouse. In another embodiment, the mouse sensor may output only data related to reflected light from the work surface, and the information processing apparatus 2 may output, based on the data, whether the mouse has been moved, or the movement direction, the amount of movement, etc., of the mouse. The same applies to the attitude sensor, and either the information processing apparatus 2 or the mouse 40 may calculate the actual attitude.

The shape of the mouse 40 in the above embodiments is an example. For example, a grip that is easy for the user to hold and lift up may be provided. As an example, the mouse 40 may be used like a general game controller. That is, a game controller having the mouse sensor is included in a range of the mouse 40 of the present disclosure. In addition, the mouse 40 may be attachable to and detachable from another apparatus.

In the above embodiments, sound adjustment based on the second parameter and the third parameter may not necessarily be performed. In addition, sound adjustment may be performed based on any one or two of the first parameter, the second parameter, and the third parameter. Furthermore, in place of or in addition to these parameters, sound adjustment may be performed based on another parameter.

In addition, regarding the first parameter and the second parameter, control may be performed such that a sound is adjusted by each of the parameters, or the sound adjusted by the first parameter is further adjusted by the second parameter, for example. As a matter of course, the same control method may be used for the third parameter.

In the above embodiments, an example of moving the mouse 40 along the rod-shaped object has been provided, but the configuration is not limited thereto. The mouse 40 may be moved on a flat surface such as a desk or a wall used as the work surface. In this case, it is possible to provide game processing that involves offering amusement of finding, as an object to be used as the work surface for the mouse 40, an object having just the right angle therefor, for example.

The output sound may be changed depending on the material of the work surface. For example, the difference in the work-surface reflective properties may be outputted from the mouse sensor as data related to reflected light, and parameters regarding the output sound may be determined based on the data.

The output sound may be changed in accordance with an operation on the button of the mouse 40 or on a stick (not shown) provided on the mouse 40. In addition, when the mouse 40 and a controller other than the mouse 40 are used simultaneously, the output sound may be changed in accordance with the attitude and movement of, or an operation on, the other controller.

In the above embodiments, the parameters related to the output sound are determined based on the attitude, the movement direction, or the movement speed of the mouse 40. However, in place of or in addition to these parameters, a parameter may be determined based on another state or movement related to the mouse 40. As an example, the parameter may be determined based on the amount of movement of the mouse 40. For example, the parameter may be set such that the larger the amount of movement of the mouse, the higher the scale. In addition, as an example, the parameter may be determined based on the rotation of the mouse 40 on the work surface. Furthermore, as an example, the output sound may be changed based on the acceleration detected by the acceleration sensor. For example, the output sound is made higher in accordance with an increase in the acceleration.

During the movement of the mouse 40, the first parameter may be prevented from being changed or a change in the first parameter may be suppressed even when the attitude of the mouse 40 is changed. Thus, it is possible to suppress a change in the output sound caused by an unintended change in attitude while the mouse 40 is moving.

In the above embodiments, the sound being outputted is attenuated when the mouse is not moving. However, even when the mouse is moving, the previously outputted sound may be attenuated while a new sound may be outputted by being superimposed thereon.

Appropriate display may be performed on the display unit 30 in accordance with the above-described processes. For example, information related to the currently outputted sound (such as the octave, scale, etc.) may be displayed on the display unit 30. In addition, an image showing a target attitude of the mouse 40 (or a parameter related to the attitude) and the current attitude of the mouse 40 may be displayed. At this time, an evaluation based on the degree of match between the target attitude and the current attitude may be performed. In addition, display related to a push and pull state of the mouse 40 or display of an instruction for push and pull may be performed.

The mouse 40 may include a vibrator. In this case, the aspect of vibration may change in accordance with an output sound. For example, the intensity and frequency of the vibration may be changed in accordance with each parameter. In addition, for example, the vibrator may be vibrated while the mouse 40 is moving on the work surface. At this time, even when a sound is being outputted, the vibration may be stopped if the mouse 40 is no longer moving on the work surface. Thus, in the second embodiment, it is possible to express the state where, for example, when the bow of the virtual violin is separated from the strings, a sound is still being produced although the bow is separated from the strings. That is, it is possible to express the state where the bow is separated from the strings by stopping the vibration. The vibrator of the mouse 40 may be the sound output unit 31.

In the above-described exemplary embodiment, a case has been described where the game processing as described above is executed by a single information processing apparatus 2. The information processing apparatus 2 may include a plurality of storages and processors. The game processing may be shared and executed by these storages and processors. In addition, the information processing apparatus may be a server, and the game processing may be executed in a distributed system including a plurality of information processing apparatuses including the server.

While the present disclosure has been described in detail, the foregoing description is in all aspects illustrative and not restrictive. It is to be understood that numerous other modifications and variations can be devised without departing from the scope of the present disclosure.

What is claimed is:

1. One or more non-transitory computer-readable storage media having stored therein instructions that, when executed, cause one or more processors to perform game operations comprising:
acquiring first data outputted from a mouse and related to an attitude of the mouse;
acquiring second data outputted from the mouse and related to movement of the mouse on a work surface;
determining a first parameter related to sound data, based on the acquired first data; and
outputting, based on the acquired second data, the sound data determined based on the first parameter.

2. The one or more non-transitory computer-readable storage media according to claim 1, wherein the game operations further comprise:
determining, based on the acquired second data, a second parameter different from the first parameter and related to the sound data; and
outputting the sound data based on the first parameter and the second parameter.

3. The one or more non-transitory computer-readable storage media according to claim 2, wherein the game operations further comprise determining the second parameter, based on a movement direction of the mouse determined based on the second data.

4. The one or more non-transitory computer-readable storage media according to claim 3, wherein the game operations further comprise determining the second parameter, based on whether the movement direction of the mouse determined based on the second data is a first direction or a second direction opposite to the first direction.

5. The one or more non-transitory computer-readable storage media according to claim 2, wherein the game operations further comprise determining, based on a movement speed of the mouse determined based on the second data, a third parameter different from the first parameter and the second parameter and related to the sound data.

6. The one or more non-transitory computer-readable storage media according to claim 1, wherein the game operations further comprise stopping output of the sound data when a series of movement distances of the mouse in a same direction, determined based on the second data, reaches a specified distance or more.

7. The one or more non-transitory computer-readable storage media according to claim 1, wherein the game operations further comprise:
detecting that the mouse is not moving on the work surface, based on the second data; and
gradually reducing a volume of the outputted sound data from a time when the mouse is detected as not moving on the work surface.

8. A computer-implemented method comprising:
acquiring first data outputted from a mouse and related to an attitude of the mouse;
acquiring second data outputted from the mouse and related to movement of the mouse on a work surface;
determining a first parameter related to sound data, based on the acquired first data; and
outputting, based on the acquired second data, the sound data determined based on the first parameter.

9. The computer-implemented method according to claim 8, further comprising:
determining, based on the acquired second data, a second parameter different from the first parameter and related to the sound data; and
outputting the sound data based on the first parameter and the second parameter.

10. The computer-implemented method according to claim 9, further comprising determining the second parameter, based on whether a movement direction of the mouse determined based on the second data is a first direction or a second direction opposite to the first direction.

11. The computer-implemented method according to claim 9, further comprising determining, based on a movement speed of the mouse determined based on the second data, a third parameter different from the first parameter and the second parameter and related to the sound data.

12. The computer-implemented method according to claim 8, further comprising stopping output of the sound data when a series of movement distances of the mouse in a same direction, determined based on the second data, reaches a specified distance or more.

13. The computer-implemented method according to claim 8, further comprising:
detecting that the mouse is not moving on the work surface, based on the second data; and
gradually reducing a volume of the outputted sound data from a time when the mouse is detected as not moving on the work surface.

14. A game system comprising:
a mouse having an optical sensor and an attitude sensor;
one or more processors; and
one or more non-transitory computer-readable storage media having stored therein instructions that, when executed, cause the one or more processors to perform game operations comprising,
in the mouse,
transmitting first data related to an attitude of the mouse and based on output of the attitude sensor, and
transmitting second data that is based on output of the optical sensor and is related to movement of the mouse on a work surface, and
in the one or more processors,
determining a first parameter related to sound data, based on the first data acquired from the mouse, and
outputting, based on the second data acquired from the mouse, the sound data determined based on the first parameter.

15. The game system according to claim 14, wherein the game operations further comprise:
determining, based on the acquired second data, a second parameter different from the first parameter and related to the sound data; and
outputting the sound data based on the first parameter and the second parameter.

16. The game system according to claim 15, wherein the game operations further comprise determining the second parameter based on whether a movement direction of the mouse, determined based on the second data, is a first direction or a second direction opposite to the first direction.

17. The game system according to claim 15, wherein the game operations further comprise determining, based on a movement speed of the mouse determined based on the second data, a third parameter different from the first parameter and the second parameter and related to the sound data.

18. The game system according to claim 14, wherein the game operations further comprise stopping output of the sound data when a series of movement distances of the mouse in a same direction, determined based on the second data, reaches a specified distance or more.

19. The game system according to claim 14, wherein the game operations further comprise:
detecting that the mouse is not moving on the work surface, based on the second data; and
gradually reducing a volume of the outputted sound data from a time when the mouse is detected as not moving on the work surface.
